(19) United States
(12) Patent Application Publication
(10) Pub. No.: US 2014/0308476 A1
(43) Pub. Date: Oct. 16, 2014

(54) COEXTRUDED LASER WELD ENABLED POLYMER FILM OR FILAMENT AND FABRICS MADE THEREFROM

(71) Applicant: AstenJohnson, Inc., Charleston, SC (US)

(72) Inventor: Allan R. Manninen, Stittsville (CA)

(21) Appl. No.: 14/358,759

(22) PCT Filed: Nov. 16, 2012
(86) PCT No.: PCT/CA2012/001065

§ 371 Date: May 16, 2014

(30) Foreign Application Priority Data
Nov. 17, 2011 (CA) 2,758,622

(51) Int. Cl. B32B 27/36; B32B 37/04; B32B 3/26; D01F 8/14; B32B 27/08

(52) U.S. Cl. CPC B32B 27/36; D01F 8/14; B32B 27/08; B32B 3/266; B32B 37/04; B32B 2250/244; B32B 2264/108; B32B 2307/518; B32B 2307/54
USPC 428/138; 428/480; 428/373; 428/213; 428/220; 428/221; 156/272.8

(57) ABSTRACT

An oriented multi-layer polymer material, an industrial textile and seaming elements therefor, and methods of manufacture. The polymer material comprises at least two thermoplastic polymeric layers, wherein at least one of the layers includes a radiation absorbent material to provide a weldable outer surface of the polymer material and at least one of the layers permits through transmission of laser energy. The polymer material can be provided as a bi-axially oriented film or as a filament; and allows for accuracy and reliability of welding, while avoiding the disadvantages associated with accurate placement and alignment of separate welding strips.

### FIELD OF THE INVENTION

The invention relates to multi-layer polymer films and filaments, and in particular to oriented coextruded films and filaments in which there is at least one layer which includes a radiation absorbent material in quantities sufficient to render the film or filament weld-enabling during a subsequent through-transmission laser welding process. Such films and filaments can be used for a variety of industrial purposes, in particular for use as, or incorporated within, industrial textiles, or within seaming elements for such textiles.

### BACKGROUND OF THE INVENTION

In industrial processes, polymeric sheet or film materials are conventionally joined by various means including through transmission laser welding (TTLW). In the known TTLW processes, a laser energy absorbent “partner” material is used to create the weld with at least one other material which is transparent to laser energy. The partner material is either: (a) located between the two surfaces to be joined, at least one of which is transparent to laser energy; (b) a suitable radiant energy absorbent material applied as a generally uniform and dispersed dye or similar material within, or as a coating to, at least one of the surfaces to be joined, and at least one of the two surfaces is transparent to the radiant energy; or (c) one of the two surfaces to be joined, while the other is transparent. The weld is created by passing the laser energy, typically from an infrared laser, through the transparent material so that its energy is incident on, and absorbed by, the absorbent material. The laser energy heats the absorbent material, particularly at or near its outer surface, to the melting point of the material, thereby forming and securing the weld.

Laser welding of various thermoplastic compositions is well known. See, for example, U.S. Pat. No. 8,038,838 (Terada et al.); U.S. Pat. No. 7,268,175 (Koshida et al); US 2011/0256406 (Farrell et al.); US 2007/0161730 (Koshida et al.); US 2006/0108064 (Mori); US 2005/0137325 (Koshida et al.); US 2004/0112519 (Mori); US 2003/0132554 (Grosser et al.); US 2003/0130381 (Joachimi et al.); and EP 1 542 855 (Kobayashi).

U.S. Pat. No. 7,922,859 (Rosenberger) discloses laser-weldable polymers consisting of a laser transparent part and a laser-absorbent part which can be welded together; the laser absorbent part comprises, as absorber, copper hydroxide phosphate and/or copper phosphate.

US 2009/0130451 (Farrell) discloses a laser weld enabled composition containing a thermoplastic polymer, a near-infrared absorber, carbon black and a white pigment.

EP 1 864 784 (Shimasaki) discloses a method of bonding substrates for use in creating chips for bioassay by forming the first and second substrates from an optically transparent material; part of the bonding faces are formed from an optically absorbent substance. The parts are bonded by passing incident radiation through the first transparent material onto the absorbent substance at their interface. It further discloses that the melting points of both substrates should be the same (so that both melt when exposed to radiation), and that carbon black be present in amounts of at least 0.01 vol %. Pressure is applied to the weld area through a sheet of glass and optionally a transparent plate having an irregular surface to prevent sticking. The layer containing the carbon black is formed by injection molding.

EP 1920686 (Fischer) discloses a fluid conduit connecting assembly in which the connecting sleeve is formed of a co-extruded thermoplastic material of which one portion of the co-extrusion is optically transparent while the other is laser energy absorbent. This bi-component structure enables the connecting sleeve to be welded to a first line and ensure a seamless fit. The laser energy absorbent portion of the co-extrusion contains from 1% to 5% parts by weight carbon black.

US 2011/0200791 (Kugelmann et al.) describes a method for producing a composite part by transmission laser welding, comprising the steps of: (a) providing a flat arrangement of a multilayer film (2) comprising a joining layer on a hard plastic part (1) such that the joining layer abuts the hard plastic part (1), wherein the joining layer comprises an absorber for laser light, (b) pressing the multilayer film (2) onto the hard plastic part (1) using a pressing tool (4) pervious to laser light, and (c) irradiating the arrangement obtained in step (b) with laser light from the side of the multilayer film (2).

In relation to multi-layer polymeric sheet materials or filaments, the known methods suffer from various disadvantages, including the difficulties associated with ensuring accurate placement and alignment of the absorbent material such as strips and the polymeric sheet materials. The major problem with these known methods is that efficacy of the weld, and thus the resulting join, is very sensitive to any gaps and other irregularities which may be manifested in the surfaces between the joining partner and the material to which it is to be joined. In order to assure weld quality, it is usually necessary to apply sufficient pressure to the parts that are to be welded to ensure intimate contact and proper fit between the components, and such pressure can have disadvantageous effects, such as damage or distortion of areas adjacent to the weld area.

In addition to the above considerations, the effectiveness of a TTLW process will also be determined in part by the optical properties of the transparent polymer(s) involved. Additives present in these polymers, such as fillers, dyes and pigments, will have an impact on the ability to effect a strong weld. The optical properties of the transparent polymer(s) will be impacted by the absorbing and scatter effect of any additives present which are, in turn, dependent on their concentration, the additive type, particle size and dispersion, as well as the wavelength of the incident radiation. With respect to the laser energy absorber partner material, factors such as reflection, transmission, absorption, diffusion coefficient, refractive index, and optical penetration depth will all be influenced by the absorber concentration and the spectral absorption of the absorber. In short, there is a multiplicity of factors which may adversely impact weld quality in a TTLW process. In particular, in the case of industrial textiles such as papermaking and similar fabrics, there are further difficulties arising from the need for uniformity of thickness through the textiles, especially for ensuring that there is no significant discontinuity at seam areas.

Ideally, a single interface between the partner material and the component to which it is to be attached should be provided; such an interface should be less sensitive to gaps and other surface irregularities and should provide a uniform and predictable energy absorbent partner material and thus an effective weld between the components involved.

It has now been found that biaxially oriented multi-layer coextruded polymer films can be constructed to comprise at least one layer which includes a radiation absorbent material in quantities sufficient to render the film weld-enabling during a subsequent through-transmission infrared laser welding process. It has further been found that a similar layer of radiation absorbent material can be provided within a coextrusion process to provide oriented multi-layer polymeric filaments.

### SUMMARY OF THE INVENTION

In the oriented films and filaments of the invention, at least one layer of the coextruded film or filament is comprised of a first thermoplastic polymer that is effectively transparent to laser energy in that any additives or fillers which may be present (such as titanium dioxide or other colorants, for example) have minimal impact on its optical properties insofar as they relate to the ability of the polymer to transmit the incident laser energy. If the film or filament is expected to undergo any prolonged exposure to heat and moisture, preferably the film or filament material is hydrolytically stabilized prior to extrusion, so as to enable it to resist degradation. The first thermoplastic polymer is preferably a polyester, and most preferably it is polyethylene terephthalate (PET).

As used herein, the term “orienting” means the process of heating and stretching the polymer material so as to impart stretch-induced structure to the film or filament, by straightening out the polymer chains in the film or filament, to provide very small strain induced crystals with the desired morphology. The associated term “oriented” identifies a film or filament which has been subjected to an orienting process. The films of the invention are preferably biaxially oriented, i.e. oriented in both the machine direction (MD) and transverse direction (TD); whereas the filaments of the invention will be oriented only in the longitudinal direction.

As used herein, the terms “transparent” or “relatively transparent” mean that there is little reduction in the intensity of the laser energy as it travels through a transmission medium such as a film layer which does not contain a radiation absorbent material, such as carbon black or other laser energy absorbent material additive. The first polymer must be sufficiently transparent such that adequate laser energy passes through the first polymer in order to melt the second and form the necessary weld.

A second factor involving the effective transparency of the first (non-absorbent) film layer, is the transmission distance through that layer, i.e. it must be sufficiently thin such that there is no undue attenuation of the radiation so that sufficient radiation is transmitted through to the second layer so as to melt it through its thickness to provide the necessary weld. For example, if the overall thickness of the multilayer construction ranges from 100 μm to about 500 μm, and the thickness of the energy absorbent layer is 5%-15% of this total, then the thickness of the first transparent layer must be between from 85-95 μm (for total film thickness of 100 μm) and 475-425 μm (for thickness 500 μm). Within this range, a first layer of PET including minimal amounts of additives such as TiO2 and any colorants/dyes would be effectively transparent.

At least one second layer, which is co-extruded with and joined with the first in the feedblock or die during extrusion to form a single structure, is comprised of a second film or filament forming thermoplastic polymer which is capable of forming a sufficiently strong bond with the first polymer in the first layer so as to minimize depolymerization at the locus of subsequent welds. The second polymer may, but need not, be the same as the first, but will be at least partially miscible and compatible, with the first polymer forming the first layer, and may have a similar melt viscosity and melt temperature to that of the first polymer. Preferably, the first and second polymers are the same; more preferably, the first and second polymers are both polyesters, most preferably PET.

The second polymer contains a suitable laser energy absorbent material additive which is uniformly incorporated into and dispersed within the polymer during a melt blending process and is present in an amount sufficient to render the second film layer weld-enabling during a subsequent TTLW. A particularly suitable additive is carbon black; however, other additives such as clear or dyeable products e.g. Clearweld® (available from Gentex Corporation of Carbondale, Pa.) or Lumogen® (available from Basf Corporation) may also be suitable, depending on the intended end use. Appropriate amounts of the additive will depend on the additive selected, but where the additive is carbon black, it is preferably present in amounts ranging from about 0.1% pbw to about 1.0% pbw (parts by weight) based on the total weight of the second polymer. The amount of laser energy absorbent material additive incorporated into the second polymer will be dependent on the intended final thickness of the second polymer layer in the coextruded film, taking into account the wavelength of the laser intended to be used in the TTLW process. Additional layers can be provided to the film or filament in the coextrusion process to meet the intended end use of the film or filament. The coextruded multilayer film may be comprised of as many layers as may be deemed necessary to provide sufficient mechanical properties to the final film so as to render it suitable for the intended end use.

For example, if the intended end use of the film or filament would be more advantageously met by selecting first and second polymers which are not similar or at least partially miscible with one another, a third polymer layer, comprised of a suitable polymer or copolymer, can be used as a tie layer to ensure secure internal bonds for the overall film or filament. In other instances, a third, fourth or more layers may be included in the film depending on its desired mechanical properties.

This layer thickness is selected such that, in combination with a sufficient amount of the laser energy absorbent material additive which is dispersed throughout the absorbent layer, a sufficient amount of the laser energy is converted into heat throughout the layer, causing the relatively thinner energy absorbent layer to melt entirely and form a weld with a second polymeric material. A poor weld will result if the absorbent layer is too thick or if there is high attenuation (i.e. losses) of radiation as the energy passes through it. If the absorbent layer is overly thick, too much of the incident laser energy will be converted into heat at or near the outer surface interface of the absorbent layer adjacent the first polymer layer, and the interior of the absorbent layer will be heated primarily by conduction. It is well known that polymers are poor thermal conductors and do not transfer heat well. Polymers also have significantly higher specific heat capacities than other materials, such as metals and ceramics, and therefore more energy is required to increase their temperature in comparison to these materials. In a TTLW process, which is usually a highly automated, high throughput process, an overly thick or highly attenuating material will not be able to transmit sufficient energy through its thickness to melt the entire layer, resulting in a poor quality weld. In addition, if the second layer is overly thick, the mass at the point of exposure might overheat the polymer in the first layer, causing it to degrade and leading to premature failure or delamination of the layers at the weld points. Therefore, for example, for overall film or filament thicknesses in the range of from about 100 μm to about 500 μm, taking into account the complete or total thickness of all polymer layers together, the thickness of the second polymer layer containing the laser energy absorbent material additive should preferably be between about 5% to 15% of the total film or filament thickness. This will provide a ratio of thickness of the second polymer layer to that of the complete film or filament, in the range of from 0.05:1 to 0.15:1. Thus, for films or filaments whose thickness is about 100 μm, the thickness of the second layer containing the laser energy absorbent material additive would be from 5 μm to 15 μm; for films or filaments having an overall thickness of 500 μm, the thickness of the second layer would be from 25 μm to 75 μm.

As noted above, the laser energy absorbent material additive in the second polymer can be any suitable radiation absorbent material, but is preferably carbon black. Preferably, the energy absorbent material is capable of absorbing energy in a TTLW process in a wavelength range between 800 nm and 1200 nm, and more preferably in a wavelength range between 900 nm and 1100 nm.

The invention therefore seeks to provide an oriented multi-layer polymer material comprising at least two thermoplastic polymeric layers, wherein at least one of the layers includes a radiation absorbent material to provide a weldable outer surface of the polymer material and at least one of the layers permits through transmission of laser energy.

Preferably, the at least two thermoplastic layers are coextruded. The oriented multi-layer polymer material can be selected from a film and a filament. Where the polymer material is a filament, preferably it has a two layer construction, wherein one layer includes the radiation absorbent material; and preferably the filament has a substantially rectangular cross-section.

Where the polymer material is a bi-axially oriented film, it may comprise two layers, or optionally at least three layers, in which case optionally at least two of the layers include the radiation absorbent material. Where the polymer material comprises at least three layers, two layers can include the radiation absorbent material, each comprising an outer surface of the polymer material.

Where the polymeric material is a film, preferably a ratio of a total thickness of each layer including the radiation absorbent material to a total thickness of the complete film is in the range of from 0.05:1 to 0.15:1, and preferably the total thickness of the complete film is in a range between 100 μm and 500 μm.

Preferably the radiation absorbent material is carbon black and is in an amount of between about 0.1% pbw to about 1.0% pbw (parts by weight) in relation to the layer including the carbon black.

Where the polymer material is a film, it preferably has a tensile strength in a range between 150 MPa and 300 MPa, more preferably in a range between 175 MPa and 275 MPa. Preferably, the film has an elongation at break in a range from 150% to 250%, more preferably in a range from 160% to 220%.

Preferably each layer including the radiation absorbent material comprises PET, and preferably each layer which provides through transmission of laser energy also comprises PET. In each case, preferably the PET has an intrinsic viscosity in a range from 0.55 to 1.0; more preferably the PET has an intrinsic viscosity in a range from 0.6 to 0.8.

Optionally, at least one of the layers which provides through transmission of laser energy includes a visually contrasting dye or pigment.

The invention further seeks to provide a seaming element for an industrial textile, wherein the seaming element is constructed of a polymer material according to the invention; an industrial textile comprising an opposing pair of seamable edges, wherein at least one of the seamable edges comprises a seaming element according to the invention; and an industrial textile constructed of an oriented multi-layer polymer material according to the invention.

The invention further seeks to provide an industrial textile comprising a polymer film of the invention, wherein the film is profiled and has first and second layers, at least the first layer comprising a plurality of raised portions each defining one of a plurality of apertures operatively alignable to apertures in the second layer to provide for fluid flow through both layers.

The industrial textiles of the invention can comprise an opposing pair of seamable edges, wherein at least one of the seamable edges comprises a seaming element according to the invention.

The invention further seeks to provide a method of constructing a weldable multi-layer polymer material, comprising the steps of

(a) providing a first thermoplastic polymer material which is substantially transparent to laser energy;

(b) providing a second thermoplastic polymer material including a radiation absorbent material;

(c) combining the first and second thermoplastic materials to form the multi-layer polymer material in which the second thermoplastic polymer material comprises a weldable outer surface of the multi-layer polymer material; and

(d) performing a heating and stretching process on the multi-layer polymer material to provide an oriented multi-layer polymer material.

Preferably the combining in step (c) is performed by co-extrusion of the first and second thermoplastic materials.

The multi-layer polymer material can be provided in a structure selected from a film and a filament. Where it is provided as a filament, preferably it has a two layer construction, comprising one layer of the second thermoplastic material, and preferably is provided with a substantially rectangular cross-section.

Where the polymer material is a bi-axially oriented film, it may comprise two layers, or optionally at least three layers, in which case optionally at least two of the layers include the radiation absorbent material. Where the polymer material comprises at least three layers, two layers can include the radiation absorbent material, each comprising an outer surface of the polymer material.

Where the polymeric material is a film, preferably a ratio of a total thickness of each layer of the second thermoplastic material to a total thickness of the complete film is in the range of from 0.05:1 to 0.15:1, and preferably step (c) comprises providing the film with a total thickness in a range between 100 μm and 500 μm.

Preferably, step (b) comprises providing the radiation absorbent material as carbon black in an amount of between about 0.1% pbw to about 1.0% pbw (parts by weight) in relation to the second thermoplastic material.

Preferably, step (a) comprises providing PET as the first thermoplastic material, and preferably step (b) comprises providing PET as the second thermoplastic material, preferably having an intrinsic viscosity in a range from 0.55 to 1.0, more preferably in a range from 0.6 to 0.8.

Preferably step (d) includes processing the multi-layer polymer material to provide it with a tensile strength in a range between 150 MPa and 300 MPa, more preferably in a range between 175 MPa and 275 MPa.

The invention further seeks to provide a method of providing a seaming element for an industrial textile, comprising the steps of

(a) providing a weldable multi-layer polymer material according to the invention; and

(b) constructing a seaming element from the polymer material, wherein at least one outer surface of the seaming element comprises a layer of the second thermoplastic material.

The invention further seeks to provide a method of seaming an industrial textile, comprising the steps of

(a) providing a pair of seaming elements according to the invention; and

(b) securing one of the pair of seaming elements at each of an opposing pair of seamable edges of the industrial textile.

As noted above, where the polymer material is an oriented extruded film having a thickness in the range of from about 100 μm to about 500 μm, then following an orientation process including an extrusion, stretching and heatsetting process, the film will have machine direction (MD) and transverse direction (TD) tensile strengths that are preferably in the range of from 150 MPa to 300 MPa, and more preferably are from 175 MPa to 275 MPa. Generally the TD tensile strength is substantially the same as the MD tensile strength. However, it will be understood that the MD and TD tensile strength values of the film may not be the same, and will vary depending on the amount of stretch imparted in each direction. For some applications, it may be preferable that the values are different; for example, for use in a seaming element, it may be preferable to provide a greater tensile strength in the TD.

It has been found that films exhibiting MD and TD tensile strengths in this range will perform well in applications such as in the industrial textiles herein described. As the term is used herein, “tensile strength” is determined according to the procedure described in ASTM D 882 “Standard Test Method for Tensile Properties of Thin Plastic Sheeting”. Preferably, the MD elongation at break for these films, as determined according to the method described in ASTM D 882 and expressed as a percent, will be in the range of from about 150% to about 250%; preferably the MD elongation at break is from about 160% to about 220%.

Preferably, the MD shrinkage of the films of the invention is less than 2%, more preferably less than 1% (the shrinkage values are given at 150° C. for 30 minutes). Preferably, the TD shrinkage and the MD shrinkage are substantially similar. MD and TD shrinkage values are determined according to the method provided in ASTM D 1204 “Standard Test Method for Linear Dimensional Changes of Nonrigid Thermoplastic Sheeting or Film at Elevated Temperature”.

Experimental Results

Films were made in accordance with teachings of the invention and were tested to determine their tensile strength in both the MD and TD, as well as their corresponding elongation and shrinkage in both these directions as compared to a similar film which did not contain carbon black as a component. Three experimental and one control film were extruded and tested and the results appear as Table 1 below.

TABLE 1

| | | | | Tensile | |
|---|---|---|---|---|---|
| | | | Elongation at | Strength | |
| | | Shrinkage (%) | Break (%) | (MPa) | Film Thickness |
| Sample No. | Composition | MD/TD | MD/TD | MD/TD | (μm) |
| 1 | PET + | 1.2/1.4 | 166/142 | 167/176 | 252 |
| | Stabilizer + CB | | | | |
| 2 | PET + | 1.0/1.1 | 155/144 | 162/177 | 253 |
| | Stabilizer + CB | | | | |
| 3 | PET + | 1.3/1.1 | 150/130 | 167/176 | 257 |
| | Stabilizer + CB | | | | |
| 4 | PET + Stabilizer | 1.4/1.1 | 189/166 | 192/205 | 251 |

In Table 1, the PET used in all samples was Invista Type 8326 polyester resin available from Invista which is a fiber grade, semi-dull luster PET resin having an intrinsic viscosity, after a solid state polymerization process, of 0.72. The stabilizer used was Stabaxol KE7646 available from Rheine Chemie. The carbon black was Renol Black ATX 401 masterbatch from Clariant Corporation, Masterbatches Division (Holden-Clariant Masterbatches). Samples 1, 2 and 3 were each extruded as 250 μm thick films, each including a centre layer approximately 200 μm thick which did not contain any carbon black, and two outer layers each 25 μm in thickness and which contained less than 1.0% pbw carbon black. Sample 4 was extruded using the same PET and stabilizer but did not contain a carbon black component. The films were extruded under normal processing conditions in the manner previously described, stretched at a ratio (MD×TD) of 3×3.2, and relaxed by an amount of 5% in the MD.

The films were then tested to determine their shrinkage in both the MD and TD according to the method provided in ASTM D 1204 “Standard Test Method for Linear Dimensional Changes of Nonrigid Thermoplastic Sheeting or Film at Elevated Temperature”. The film samples were further tested to determine their elongation at break, and tensile strength in each direction using the test method described in ASTM D 882 “Standard Test Method for Tensile Properties of Thin Plastic Sheeting”.

The data thus obtained shows that there is only slight degradation in the mechanical properties of the films samples containing carbon black as a component of the coextrusion layers in comparison to the control sample no. 4. It would be possible to adjust the extrusion conditions so as to improve these mechanical properties so that they are comparable to those obtained without the carbon black, as later tests have confirmed.

### BRIEF DESCRIPTION OF THE DRAWINGS

The invention will now be described with reference to the drawings, in which

FIG. 1 is a cross-sectional view of a two-layered film in an embodiment of the invention;

FIG. 2 is a cross-sectional view of a three-layered film in an embodiment of the invention;

FIG. 3 is a cross-sectional view of a four-layered film in an embodiment of the invention;

FIG. 4 is a perspective view of a seaming element comprising a two-layered film in an embodiment of the invention;

FIG. 5 is a perspective partial view, with an enlarged close-up, of a profiled two-layered film in an embodiment of the invention;

FIG. 6 is a perspective partial view of the profiled two-layered film of FIG. 5 in a partially folded position for seaming;

FIG. 7 is a cross-sectional view, with an enlarged close-up, of a profiled two-layered film such as shown in FIGS. 5 and 6 in a fully folded position for seaming;

FIG. 8 is a cross-sectional view of a seam area of an industrial textile and seaming elements, including film inserts in an embodiment of the invention;

FIG. 9 is a cross-sectional view of two seamable ends of an industrial textile with seaming elements in an embodiment of the invention;

FIG. 10 is a cross-sectional view of a seamable end of an industrial textile with a seaming element in an embodiment of the invention;

FIG. 11 is a perspective partial view of a two-layered filament in an embodiment of the invention; and

FIG. 12 is a perspective view of a seaming element comprising a two-layered filament in an embodiment of the invention.

### DETAILED DESCRIPTION OF THE DRAWINGS

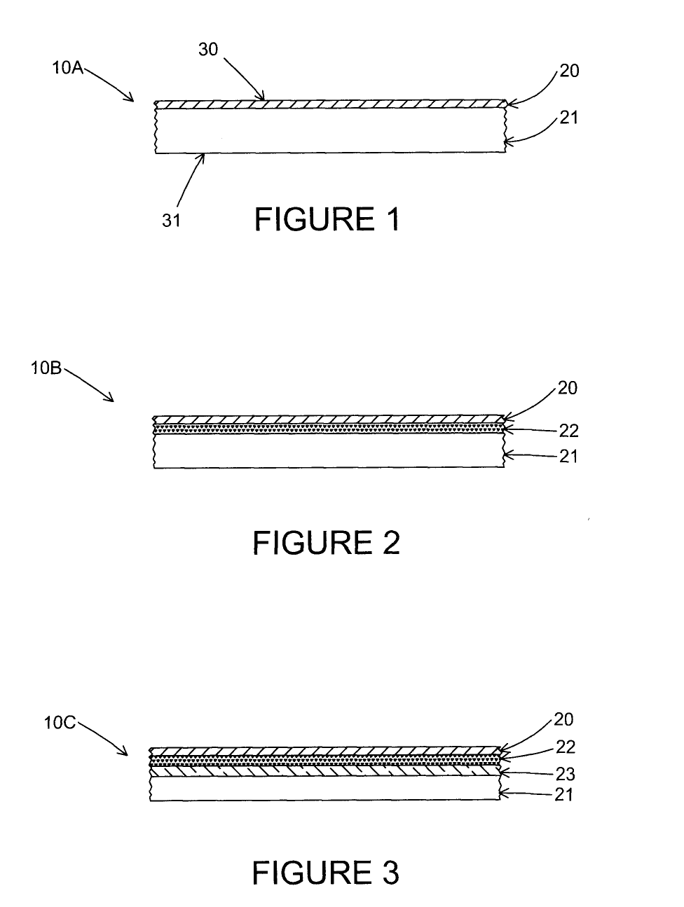

Referring first to FIGS. 1 to 3, three exemplary embodiments of the layered films of the invention are shown in cross-section. In FIG. 1, film 10A comprises a first relatively transparent polymer layer 21 which provides for transmission of laser energy with little or no attenuation throughout its thickness, having an outer surface 31; and a second polymer layer 20, having an outer surface 30, and comprising a laser energy radiation absorbent material. As discussed above, the terms “transparent” or “relatively transparent” mean that there is little reduction in the intensity of the laser energy as it travels through a transmission medium such as a film layer which does not contain a radiation absorbent material, and is sufficiently thin so as to reduce or avoid attenuation.

In FIG. 2, film 10B comprises three layers, a first transparent polymer layer 21 and a second polymer layer 20, comprising a laser energy radiation absorbent material, and an intermediate and relatively transparent third layer 22, to provide the required properties to the film, as discussed above. Similarly, FIG. 3 shows film 10C, having layers 20, 22 and 21, as in FIG. 2, and also fourth layer 23 which is also relatively transparent to laser energy.

In the embodiments shown in FIGS. 2 and 3, layers 22 or 23 can include additional materials to provide desirable properties for the intended end use of the films of the invention. For example, if a layer such as 22 or 23 is located on an exterior surface of the film, it can include a dye or pigment to enhance the visual contrast of the film, but without inhibiting the through transmission of radiation to the layer 20, i.e. by selection of a dye or pigment which is substantially transparent to the welding radiation. The addition of such dye or pigment would be useful in instances where automated sheet detection or other machine vision systems are employed to detect, for example, sheet breaks in a papermaking machine. Such a coloured layer could also provide for a visual indication of wear during use of the film in instances where it is exposed to abrasion during use. As the film becomes worn, for example during use in a papermaking or similar application, erosion of this exterior coloured layer would expose a different coloured layer beneath, thereby providing an indication of the amount of wear of the film.

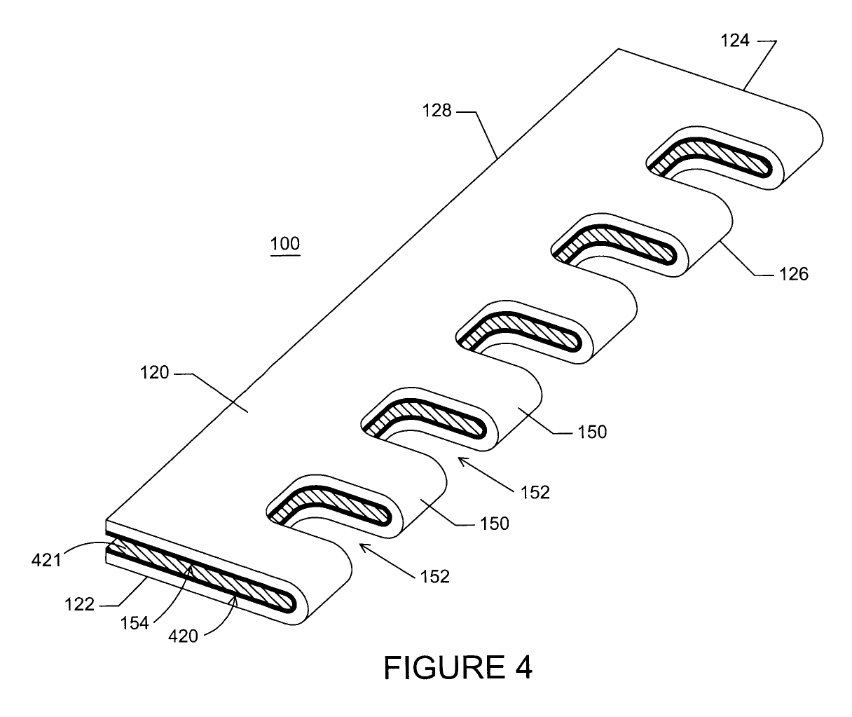

Referring to FIG. 4, this shows a seaming element 100 for an industrial textile (not shown) comprising a two-layered film, such as shown in exemplary FIG. 1, in an embodiment of the invention. Seaming element 100 is folded to provide upper outer surface 120 and lower outer surface 122, with side edges 124, leading edge 126 and opposing edge 128. At the fold line at leading edge 126, a plurality of aligned protruding loop portions 150 define apertures 152 between pairs of adjacent loop portions. Seaming element 100 is folded so that the first polymer layer creates the outer surfaces 120 and 122; and outer surface 421 of second polymer layer 420, comprising a radiation absorbent material, provides an exposed surface within the interior of seaming element 100. To provide a seam to the industrial textile, a first seamable end or edge (not shown) of the textile is aligned within seaming element 100. Radiation directed selectively through the outer surfaces 120 and 122 acts on second polymer layer 420 to secure the textile end or edge to seaming element 100. After a compatible seaming element has been secured to an opposing end or edge of the textile, the two seaming elements can be brought together in mutual alignment, for example by inserting the loop portions 150 of seaming element 100 into corresponding apertures (similar or identical to apertures 152) in the compatible seaming element, and the two seaming elements can then be secured together to complete the seam.

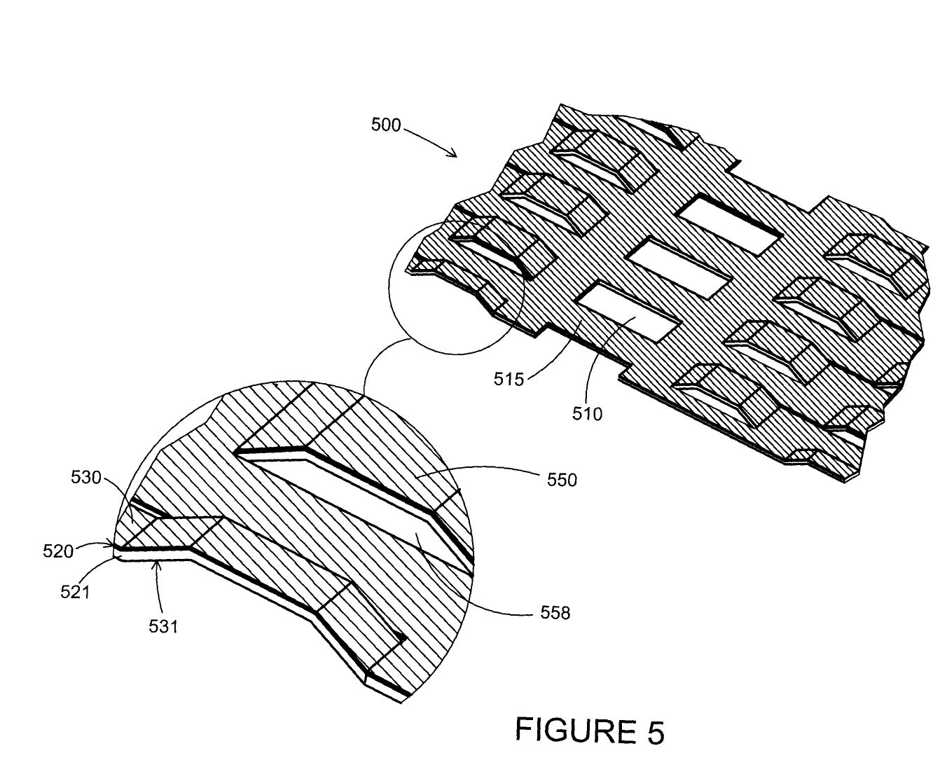

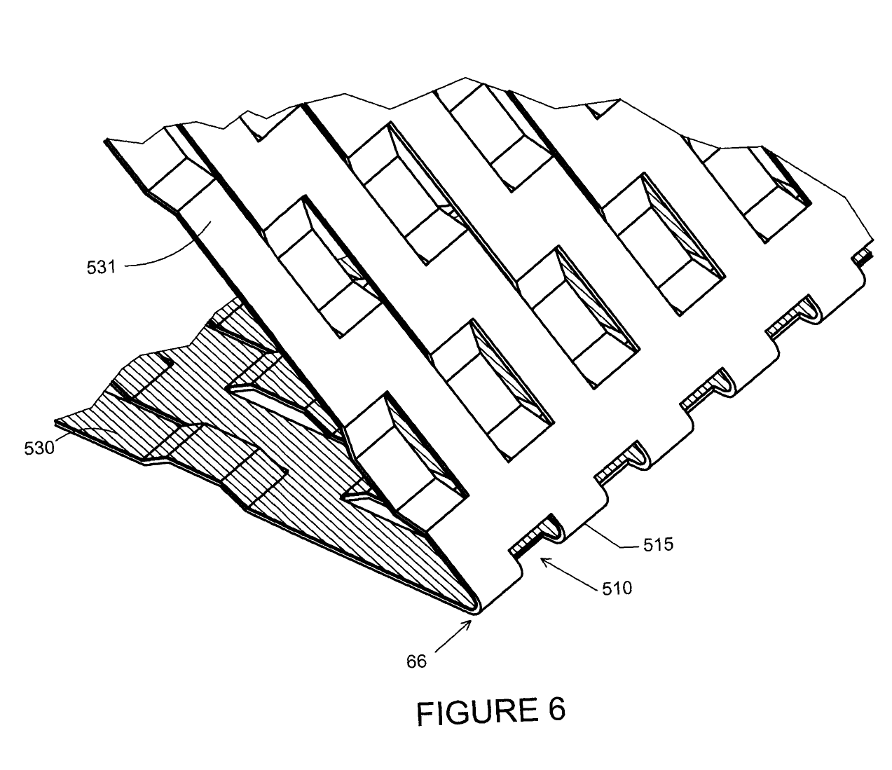

Referring now to FIGS. 5 and 6, a further embodiment of the invention is shown. FIG. 5 is a perspective partial view, with an enlarged close-up, showing a profiled two-layered film 500, comprising a plurality of raised portions 550, each defining one of apertures 558, to provide for fluid flow, such as drainage in a filtration process. At a seaming area provided between the regions comprising the raised portions 550, an aligned row of planar portions, which will be folded to become loop portions 515 (see FIG. 6) define aligned apertures 510. In the enlarged view, the layered construction of the film 500 can be seen. Upper layer 520, having upper surface 530, comprises a radiation absorbent material, and provides the upper surface to the profiled film 500 in the position shown.

Lower layer 521, having outer surface 531, provides the lower surface to the profiled film 500 in the position shown, and is transparent to laser energy.

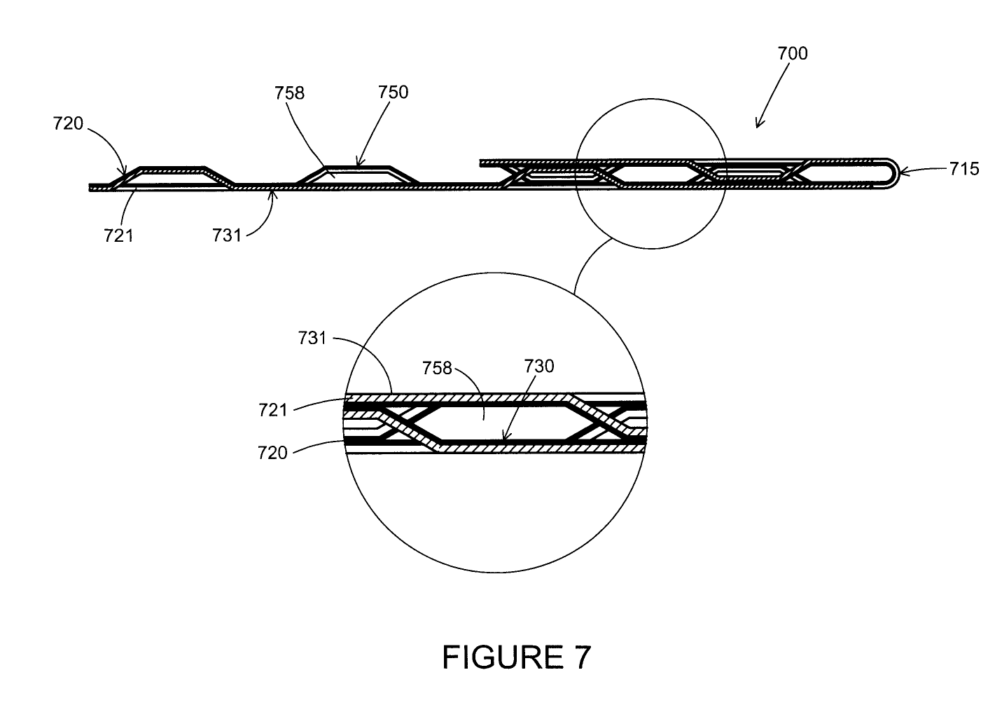

When the profiled two-layered film 500 is to be prepared for seaming, the film is folded through the intermediate position shown in FIG. 6, and then to the fully folded position, such as shown in FIG. 7. As shown in FIG. 6, the film 500 is folded along fold line 66, so that the planar portions provide protruding loop portions 515, with apertures 510 between adjacent pairs of loop portions 515. The folding step brings together the surfaces 530 on each side of the row of loop portions 515 and apertures 510, so that the outer surface 531 of the transparent layer 521 becomes the outer surface of the folded film 500.

FIG. 7 is a cross-sectional view, with an enlarged close-up, of a profiled two-layered film such as the exemplary embodiment shown in FIGS. 5 and 6, in a fully folded position for seaming. Film 700 comprises two layers, i.e. upper layer 720, comprising a radiation absorbent material, and lower layer 721 which is transparent to laser energy. At a seamable end, film 700 is folded to provide loop portions 715, so that upper layer 720 is within the interior of the fold region, and lower layer 721 becomes the outer layer of the film. As best seen in the enlarged area view in FIG. 7, outer surfaces 730 of layer 720 are in aligned contact at regions along the film. When radiation is applied to the film at selected locations, some or all of the contact areas of layer 720 will be secured together, but fluid flow apertures 758 provided by profiled raised portions 750 will not be obstructed.

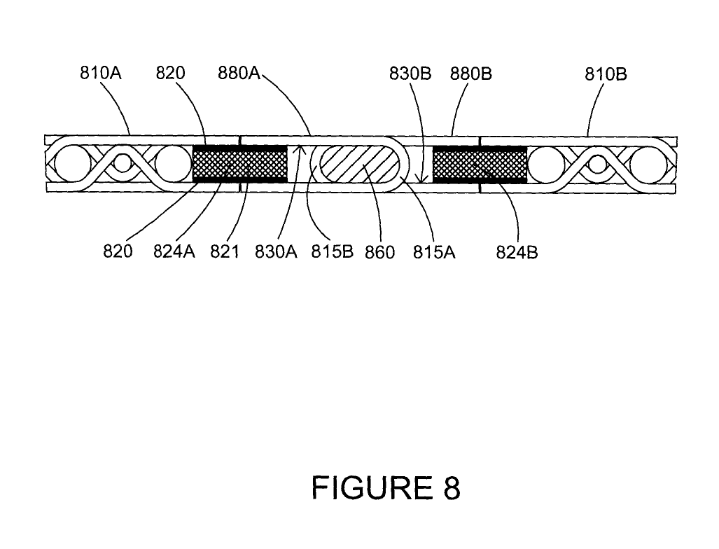

FIG. 8 is a cross-sectional view of a seam area of a woven industrial textile and seaming elements, including film inserts, each in an embodiment of the invention. Each seamable end 810A, 810B of the textile is provided with a respective one of a pair of seaming elements 880A, 880B. Film inserts 824A, 824B each comprise a central relatively transparent layer 821, between two outer layers 820 each of which comprises a radiation absorbent material. Film insert 824A is inserted between inner surfaces of seamable end 810A and inner surface 830A of seaming element 880A, both of which are comprised of relatively transparent polymeric materials. When radiation is applied to outer layers 820 through surfaces 810A and 830A, outer layers 820 are both melted by means of a TTLW process and film insert 824A is thereby secured to each of seamable end 810A and inner surface 830A of seaming element 880A, which in turn secures seamable end 810A to seaming element 880A. Film insert 824B is secured in a similar manner to seamable end 810B to inner surface 830B of seaming element 880B to secure seamable end 810B to seaming element 880B. Loops 815A and 815B can then be interdigitated to provide channel 860 for receiving a securing means such as a pintle, to close the seam for the textile.

As shown in FIG. 8, both seaming elements 880a and 880b are constructed of relatively transparent materials, as are seamable ends 810A, 810B of the textile. This is not necessary, and it would be possible to utilize a seaming element such as 100 as is presented in FIG. 4 in place of the elements 880a and 880b. If this is done, then film inserts 824a, 824b may be replaced with similarly constructed inserts which do not include laser energy absorbent materials in their outer layers 820. Alternatively, both the film inserts 824a, 824b and seaming elements 880A, 880B may be formed from multilayer films including a radiation absorbent material such as described herein.

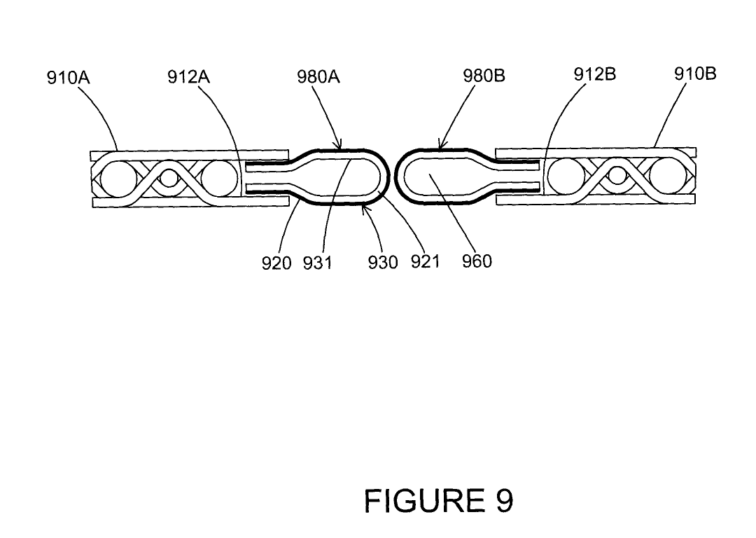

Referring to FIG. 9, a further embodiment of the invention is shown in cross-section. Two seamable ends 910A, 910B of an industrial textile are provided respectively with seaming elements 980A, 980B, which comprise first relatively transparent layer 921 with outer surface 931, and second layer 920, with outer surface 930, and comprising a radiation absorbent material. Outer surfaces 930 of each of seaming elements 980A, 980B, are secured to respective inner surfaces 912A, 912B of layers of seamable ends 910A, 910B. Seaming elements 980A, 980B comprise a plurality of looped regions, which define spaces between adjacent pairs of loops. The spaces allow the sets of loops in the two seaming elements 980A, 980B to be interdigitated in an aligned manner to provide a channel 960 through which a securing means, such as a pintle, can be inserted to secure the seam. It would be possible to utilize a bicomponent film material such as in the embodiment shown in FIG. 6 in place of the filament materials shown in relation to seamable ends 910A, 910B in FIG. 9, oriented in the manner shown in that figure such that upper layer 520 of the film containing the radiation absorbent material is oriented to the interior towards outer surfaces 930 of seaming elements 980A, 980B. If this is done, then seaming elements 980A, 980B may either be formed from a polymer material that does not include a radiation absorbent material, or such material may be present in manner shown.

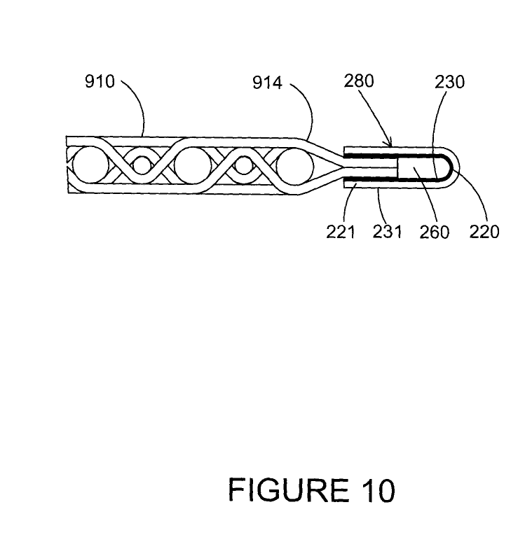

FIG. 10 shows a further embodiment of the invention in cross-section, similar to the embodiment of FIG. 9, but in which seaming element 280 is secured to outer surfaces 914 of a seamable end 910 of an industrial textile. In this embodiment, relatively transparent first layer 221 with outer surface 231 forms the outer layer of seaming element 280, and second layer 220, with outer surface 230 and comprising a radiation absorbent material, forms the inner layer of seaming element 280. Outer surface 230 of second layer 220 is secured to outer surfaces 914 of seamable end 910. In a similar manner to the embodiment shown in FIG. 9, looped portions of seaming element 280 define a channel 260 for securing seaming element 280 to a compatible seaming element (not shown) provided to an opposing seamable end (not shown) of the industrial textile.

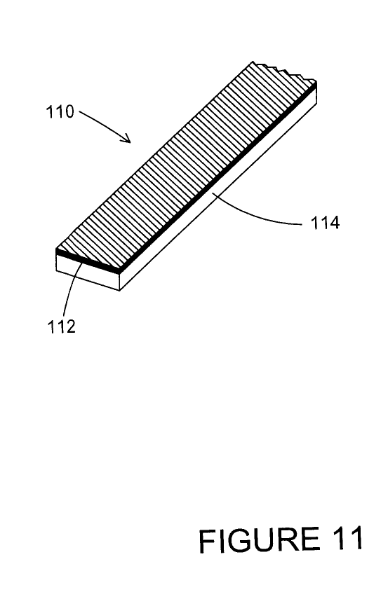

FIG. 11 is a perspective partial view of a two-layered filament 110 in an embodiment of the invention. Filament 110 has a substantially rectangular cross-section, and comprises upper layer 112 comprising a radiation absorbent material, and lower layer 114 which is transparent to radiation.

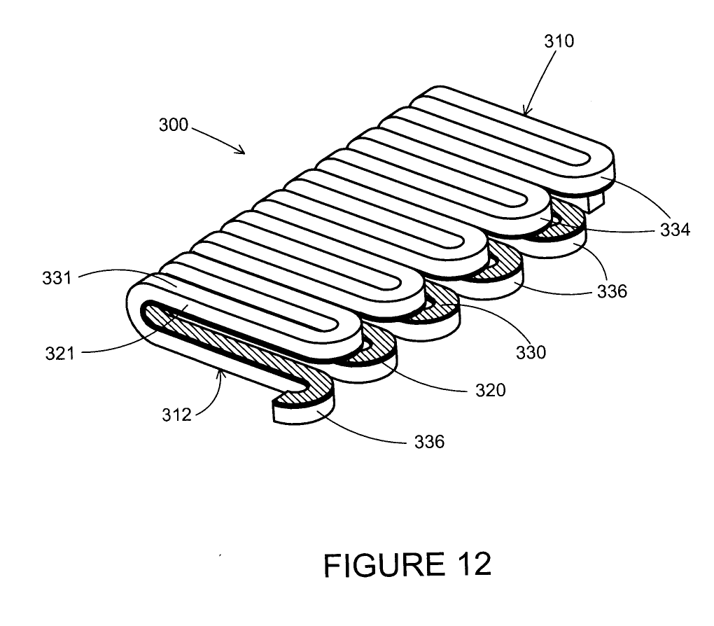

FIG. 12 is a perspective view of a seaming element 300 comprising a two-layered filament in an embodiment of the invention, constructed in the manner shown in exemplary FIG. 11. Filament 110 (see FIG. 11) can be shaped into a continuous filamentary structure, such as in FIG. 12, comprising an upper layer 310 with looped portions 334, and a lower layer 312 with looped portions 336. Seaming element 300 is constructed so that filament second layer 320, and outer surface 330, comprising a radiation absorbent material, is to the interior of seaming element 300, and filament first layer 321 and outer surface 331 is to the exterior of seaming element 300. In a similar manner to the embodiment shown in FIG. 10, seaming element 300 can be secured to outer surfaces of a seamable end of a textile (not shown). Alternatively, if the filamentary structure is shaped such that second layer 320 is to the exterior of the seaming element, and transparent layer 321 is to the interior of the seaming element, the seaming element can be inserted between and welded to inner surfaces of two layers of a seamable end of an industrial textile.

As noted above, in the film and filaments of the invention, the number of layers, and their composition, can be selected according to the intended end use, provided that the layers can be compatibly coextruded, and that the layer which includes the laser energy absorbent material is on at least one exterior surface of the resulting film or filament. As discussed above, it has been found that films of this type having an overall thickness, or caliper, that is in the range of from 100 μm to about 500 μm provide satisfactory results as the relatively transparent portions of these coextruded films in this thickness range do not impair the transmission of laser energy, provided that they are not overly filled with particulate fillers and dyes which might unduly attenuate the radiation. Further, the thickness of the laser energy absorbent portion of these coextruded films or filaments is such that the entire thickness of this portion can be melted and form a satisfactory weld when exposed to incident radiation at an appropriate wavelength. A significant advantage offered by the novel construction of these films and filaments is that the laser energy absorbent portion can be completely melted during exposure, and thus will flow and fill any gaps or irregularities in the two surfaces being joined in the welding process.

The films of the invention may be produced as follows. A first suitable transparent polymer resin, which is preferably PET or other polyester, is first obtained; an appropriate amount of a hydrolysis stabilizer such as a carbodiimide may be present in the resin depending on the intended end use of the final film so as to provide a degree of resistance to hydrolytic degradation where required; such stabilizers are known in the art. A second polymer, which is preferably compatible with, and at least partially miscible with, the first and which has a similar melt viscosity and melt temperature to the first, is also prepared; a hydrolysis stabilizer may also be present in this second polymer, depending on need. The first and second polymers may be the same, or different; preferably both are polyesters, and for many applications, PET is preferable.

As noted above in the discussion of the experimental results shown in Table 1, a suitable PET is Invista Type 8326 polyester resin, available from Invista S.a.r.l., of Spartanburg S.C., which is a fiber grade, semi-dull luster PET resin having an intrinsic viscosity of 0.72. A suitable alternative is DAK 0003, available from DAK Americas LLC, Charlotte N.C., having an intrinsic viscosity of 0.8. A suitable stabilizer is Stabaxol KE7646 available from Rhein Chemie Rheinau GmbH, Duesseldorfer Strasse 23-27, 68219 Mannheim, Germany.

The first and second polymers are preferably obtained as resin pellets which are then loaded into the hoppers of the film extruder. Appropriate amounts of a suitable laser energy absorbent material additive, such as carbon black, are added to and blended with the second polymer resin during melt extrusion such that the energy absorbent additive in the second polymer is present in amounts ranging from 0.1% to 1.0% parts by weight based on the total weight of the second polymer. A suitable carbon black is Renol Black ATX 401 masterbatch from Clariant Corporation, Masterbatches Division (Holden-Clariant Masterbatches), of Holden Mass.

Once heated to the melt point, the two polymer melts are then coextruded using either a multi-manifold die or single manifold die, depending on availability and manufacturing capability. In a multi-manifold die, individual channels extend across the die width to uniformly distribute the polymer melt so that the layers are combined prior to exiting the die. In a single manifold die, a multilayer feedblock combines the polymers at the exit of the feedports and then spreads the melt across the die channels. Either manifold die type may prove suitable. Extrusion using either die configuration will be according to conventional techniques and equipment. A three layer capability may be employed when a third intermediate layer is required, either as an adhesive tie layer, for example when the two polymers are dissimilar, or to provide an additional film layer to the overall structure for a particular intended end use.

The substantially amorphous and at least bi-component prefilm is subsequently quenched on a chill roll and then reheated and oriented in both the machine direction (MD) and transverse direction (TD) so as to impart stretch-induced structure through biaxial orientation. Where the polymer material is a filament, it will be oriented only in its longitudinal direction. In either case, this orienting step will provide a mechanically stable film or filament, as the stretching process will straighten out the polymer chains in the film or filament and provide very small strain induced crystals with the desired morphology. Stretching temperatures are normally above the glass transition temperature Tg by at least 10° C. The stretching ratio in each of the MD and TD will be about 3, but may range from 2 to about 4 as required.

There are currently two film stretching processes principally in use, i.e. simultaneous stretching, in which the film is exposed to both MD and TD forces simultaneously; and sequential stretching, in which the film is exposed first to MD and then TD stretch forces. The films of the invention can be made using the simultaneous stretch process, or sequential stretching. Depending on the end use of the film, it may be preferable to stretch the film in one of these directions over the other. A second subsequent stretch in either or both the MD and TD may also be employed as needed. The MD and TD shrinkage can be adjusted as appropriate by temperature settings and frame geometry. It should be noted that, as film thickness and carbodiimide content increases, it becomes increasingly difficult to reliably and uniformly control properties, particularly thickness. Heat setting or annealing of the film at oven temperatures of between about 170° C. to 260° C. (175° C. to 190° C. for PET) follows stretch and orientation; the film is then cooled and wound. The oriented film has a final thickness that is in the range of from about 100 μm to about 500 μm, and is preferably in the range of 175 μm to 350 μm; depending on the intended end use, the film thickness may be increased or decreased around these limits as necessary. The resulting bi-component films of the invention are thus multilayer in construction, and preferably are comprised of at least two layers.

Filaments produced in accordance with the teachings of the invention are prepared according to techniques customary for the manufacture of multicomponent thermoplastic yarns. The at least first and second polymer resins are first obtained, normally in pelletized form, and then heated separately to provide at least two polymer melts. One or both of the polymers may include an appropriate amount of a hydrolysis stabilizer, such as a carbodiimide, so as to impart to the filaments a measure of resistance to hydrolytic degradation, depending on their intended end use. Each melt is then fed separately by known means to, for example, a single manifold die, where the melts are brought together and coextruded through an appropriate die shape. If the separate polymers are miscible, their essentially laminar flows will then join together during the extrusion process; if they are not mutually compatible, then a separate tie layer may be provided as a third polymer melt which is located between the first and second polymers. Additional layers may be provided as desired. The amounts of each of the polymers fed to the die are adjusted as necessary so as to provide a thickness of the layer containing the second, laser energy absorbent material in the final filament which is in a ratio of from 0.05:1 to 0.15:1 in relation to the complete thickness of the filament. The filaments are extruded according to known methods using either a single screw or a twin screw extruder, and are provided so as to have final cross-sectional configurations which are preferably generally rectangular or square; other shapes may be suitable. Following extrusion, as noted above, the filaments will undergo an orientation step involving uniaxial (longitudinal) stretching and relaxation such as is appropriate and well known in the art of polymer extrusion, so as to align the polymer chains of the extrudate and thus provide the desired physical and mechanical properties to the resulting filament.

Where the final filament is generally rectangular or square in cross-sectional shape, such as shown in exemplary FIG. 11, it will preferably have a thickness of between about 100 μm to 500 μm, preferably about 250 μm to 350 μm including the second laser energy absorbent polymer layer; the width of the filament may be selected according to need. Where the filament has a generally circular or similar cross-section shape, its diameter will be within the same range of from 100 μm to 500 μm, preferably about 250 μm to 350 μm including the second polymer layer.

As noted above, the first and second thermoplastic polymers are preferably polyesters, such as PET, PBT, PEN and PCTA. For most applications, the preferred polymer will be PET. If used, this material should have an intrinsic viscosity which is in the range of from 0.55 to 1.0 or more, and more preferably is in the range of from 0.6 to about 0.8. Other polymers such as polyphenylene sulfide (PPS), polyetheretherketone (PEEK), polysulfones and polyamides may also be suitable for use as either, or both, the first and second polymers, provided that the selected polymers must be at least partially miscible with one another, or with a third polymer which is provided as a tie layer between the first and second layers during extrusion and that they are sufficiently transparent in the thickness range provided, such that a coextruded layer of laser energy absorbent material can be melted during a TTLW process.

As noted above, the ratio of the caliper, or thickness, of the co-extruded second layer to that of the complete film or filament is preferably in the range of from 0.05:1 to 0.15:1 (approximately 5 to 15%). For the films of the invention, for applications such as industrial textiles for conveying or filtration, the overall caliper of the film (i.e. the combined coextruded film thickness of all layers) should be in the range of between about 100 μm and 500 μm (about 400 to 2000 gauge). This thickness will provide the film with adequate mechanical properties for such industrial applications, without being too thick for the contemplated TTLW process. Preferably, the overall thickness will be in the range of between about 250 μm and 350 μm, with a preferred thickness of the layer comprising the radiation absorbent material in the range of between about 12.5 μm and 52.5 μm.

As noted above, the films and filaments of the invention are suitable for a wide variety of uses, in particular for industrial textiles and seaming elements for such textiles, more particularly for industrial textile applications for conveying and filtration. In particular, the films of the invention are particular advantageous for use in embossed slit film fabrics such as are disclosed in WO 2010/0121360, and seaming components such as are described in WO 2011/069258 and WO 2011/069259, and such as described in CA 2,749,477.

1. An oriented multi-layer polymer material selected from a film or filament and comprising at least two coextruded thermoplastic polymeric layers, wherein at least one of the layers includes a radiation absorbent material to provide a weldable outer surface of the polymer material and at least one of the layers permits through transmission of laser energy.

2.-6. (canceled)

7. An oriented multi-layer polymer material according to claim 1, wherein the polymer material comprises at least three layers.

8. (canceled)

9. An oriented multi-layer polymer material according to claim 7, wherein at least two layers including the radiation absorbent material comprise an outer surface of the polymer material.

10. An oriented multi-layer polymer material according to claim 1, wherein a ratio of a total thickness of each layer including the radiation absorbent material to a total thickness of the film or the filament is in the range of from 0.05:1 to 0.15:1.

11. An oriented multi-layer polymer material according to claim 1, wherein a total thickness of the film or the filament is in a range of between 100 μm and 500 μm.

12. An oriented multi-layer polymer material according to claim 11, wherein the radiation absorbent material is carbon black, and is present in an amount of between about 0.1% pbw to about 1.0% pbw (parts by weight) in relation to the layer including the carbon black.

13. An oriented multi-layer polymer material according to claim 12, having a tensile strength in a range between 150 MPa and 300 MPa.

14.-16. (canceled)

17. An oriented multi-layer polymer material according to claim 1, wherein each layer which permits through transmission of laser energy comprises a polyester, preferably polyethylene terephthalate (PET).

18. An oriented multi-layer polymer material according to claim 17, wherein the polyester has an intrinsic viscosity in a range from 0.55 to 1.0.

19.-22. (canceled)

23. An oriented multi-layer polymer material according to claim 1, wherein the polymer material includes a hydrolysis stabilizer.

24. A seaming element for an industrial textile, wherein the seaming element is constructed of an oriented multi-layer polymer material according to claim 1.

25. An industrial textile comprising an opposing pair of seamable edges and constructed of an oriented multi-layer polymer material selected from a film or a filament and comprising at least two coextruded thermoplastic polymeric layers, wherein at least one of the layers includes a radiation absorbent material to provide a weldable outer surface of the polymer material and at least one of the layers permits through transmission of laser energy, wherein at least one of the seamable edges comprises a seaming element according to claim 24.

26. (canceled)

27. An industrial textile according to claim 25, comprising a profiled film constructed of the oriented multi-layer polymer material and provided as first and second layers, at least the first layer comprising a plurality of raised portions each defining one of a plurality of apertures operatively alignable to apertures in the second layer to provide for fluid flow through both layers.

28. (canceled)

29. A method of constructing a weldable multi-layer polymer material, comprising the steps of:
(a) providing at least one first thermoplastic polymer material which is substantially transparent to laser energy;
(b) providing at least one second thermoplastic polymer material including a radiation absorbent material;
(c) combining the at least one first and second thermoplastic materials by coextrusion to form the multi-layer polymer material in a structure selected from a film or a filament and in which the at least one second thermoplastic polymer material comprises a weldable outer surface of the multi-layer polymer material; and
(d) performing a heating and stretching process on the multi-layer polymer material to provide an oriented multi-layer polymer material.

30.-48. (canceled)

49. A method of providing a seaming element for an industrial textile, comprising the steps of:
(a) providing a weldable multi-layer polymer material by performing the steps defined in claim 29; and
(b) constructing a seaming element from the polymer material, wherein at least one outer surface of the seaming element comprises a layer of the at least one second thermoplastic polymer material.

50. A method of seaming an industrial textile, comprising the steps of:
(a) providing a pair of seaming elements by performing the steps defined in claim 49; and
(b) securing one of the pair of seaming elements at each of an opposing pair of seamable edges of the industrial textile.
